(19) United States
(12) Patent Application Publication
(10) Pub. No.: US 2003/0210139 A1
(43) Pub. Date: Nov. 13, 2003

(54) Method and system for improved security

(76) Inventors: Stephen Brooks, Marblehead, MA (US); David F. Crosby, Sharon, MA (US)

Correspondence Address: Fred H. Zollinger, III, SAND & SEBOLT, Aegis Tower, 4940 Munson Street, NW, Suite1100, Canton, OH, 44718-3615, US

(21) Appl. No.: 10/309,615

(22) Filed: Dec. 3, 2002

Related U.S. Application Data
(60) Provisional application No. 60/336,828, filed on Dec. 3, 2001.

(51) Int. Cl. G08B 1/00

(52) U.S. Cl. 340/531; 340/541; 340/506

(57) ABSTRACT

A comprehensive method and system for providing improved security at an existing facility or providing improved security in the design of a facility to be built. The system and method can be used to evaluate an existing facility in order to determines an overall rating for a particular facility and which can also be used identify individual or elemental weakness of the facility. The method and system can analyze the data gathered during the evaluation in order to determine remedial measures that can be used to improve the facility's overall rating and strengthen the identified individual or elemental weaknesses. A comprehensive system that monitors the flow of people, vehicles, luggage, packages and airplanes in order to provide improved security is also disclosed.

### CROSS-REFERENCE TO RELATED APPLICATIONS

This application claims the benefit of priority to U.S. S. No. 60/336,828 filed Dec. 3, 2001, which is incorporated herein by reference in its entirety.

### STATEMENT REGARDING FEDERALLY SPONSORED RESEARCH

Not Applicable.

### REFERENCE TO MICROFICHE APPENDIX

Not Applicable.

### BACKGROUND OF THE INVENTION

This invention relates to a method and system for improving the security of an environment or an area, and, more particularly, to a method and system which provides for improved security at a facility including a port or terminal used in the transportation industry, such as an airport or train station.

All facilities require some form of access control or security to control access by people, whether they be employees, customer or visitors, to various areas with in the facility as well as a means to monitor the activities of these people within the facility. Some facilities further require access and control of objects (luggage, packages, vehicles, etc.) that can enter the facility. Different facilities have different requirements. Thus, the requirements of some facilities, such as military and intelligence facilities are different from ports of entry and transportation terminals (airports and train stations), which are still different from public malls or buildings. However, as the state of the art in the field advances, it becomes difficult for the owners and operators of these facilities to determine whether the facility is using the appropriate security measures for the intended level of security.

Accordingly, it is an object of this invention to an improved method and system for evaluating a security system in place at a facility.

### SUMMARY OF THE INVENTION

The present invention is directed to a comprehensive method and system for providing improved security at an existing facility or providing improved security in the design of a facility to be built. In this regard, the system and method of the invention can be used to evaluate any facility in order to determine an overall security rating for a particular facility and which can also be used identify individual or elemental weakness or deficiencies of the facility. The method and system of the present invention can also be used analyze the data gathered during the evaluation in order to determine remedial measures that can be used to improve the facility's overall rating and/or strengthen the identified individual or elemental weaknesses. The invention further includes a comprehensive system that monitors the flow of people, vehicles, luggage, packages and airplanes or other items subject to control in order to provide improved security.

The invention includes a method and system for auditing or evaluating an existing facility in order to collect data and information about the facility. The data and information can be used to determine an overall security rating and to identify the weakest elements of the overall security system of the facility. In accordance with the method, each of the components or elements of the facility is identified, including physical locations, access ways into, out of and between the physical locations, the methods and processes for characterization of all people or things entering or exiting the facility, including the methods and processes for screening all luggage and packages entering or exiting the facility and the methods and procedures for controlling the flow of people throughout the facility, including the interior and exterior areas of the facility.

Each element or component of the facility is identified, evaluated and rated. Each component is given a unique reference identifier, such as an identification number. In addition each component is also evaluated to determine a security value that reflects the appropriate or desired level of security of that component. Thus, for example, the security value for the access doors to the security command and control center for the facility can be given one of the highest values, whereas the entrance to a remote, exterior parking lot might be given a lower value. Preferably, the ratings and security values are standardized and consistent within or based upon predefined or existing industry or company standards. Alternatively, the ratings and security values can be determined as function of the risk that a breach in security at a given component would pose to the facility or the ratings and security values can be determined as a function of the desired level of control and/or access to a particular area, element or component. As part of the evaluation process, each element or component is evaluated to determine a security rating representative of the current state of the security measures in place for that element or component and to determine a security value representative of the appropriate intended or desired level of security for that element or component.

In accordance with the invention, a rating score of each component can be determined as a function of the installed security measures and the security value determined for each component and an overall rating score of the facility (or an area of a facility) can be determined as function of the rating scores of the various components. The rating scores can be used to evaluate and compare one facility with respect to another. The rating scores for each component can further be ranked or filtered in order to determine which components are in the most need of improvement.

In accordance with the invention, a system can be provided which facilitates the gathering of the data or information and can be used to determine the area, element and component ratings, security values and the overall security rating as a function of the information or data collected. The system and method of the invention can be include lists of common elements and components which can be assigned a unique component identification number as they are entered into the system, as well as provide a series of questions or queries which can be used to determine the security rating and the security value of each of the elements and components and the overall rating for the existing security system in place at the facility. The method and system of the invention can collect all the data and use the data to generate ratings, reports and recommendations for modifications which are likely to raise the performance rating of the facility.

In addition, the invention includes a method and system for analyzing the evaluation data, identifying the components that receive the lowest ratings and for identifying modifications to the existing security measures to improve the evaluation of the component and the facility and for prioritizing the same. In accordance with the invention, the method and system includes analyzing the data gathered during the evaluation process and identifying the components that have the lowest security values and using the data gathered, identify the modifications that are compatible and likely to improve the security value of the component. Thus, for example, where an access door is locked with a mechanical lock and key mechanism, the security value can be improved by providing a surveillance camera to monitor the door or by providing a numeric keypad in addition to the mechanical lock or any other method or apparatus, thus providing an additional level of security.

The invention further includes a comprehensive system for providing security in a facility or a group of facilities. The system can be incorporated as part of a process for improving the security of an existing facility or in the design of a new facility. The system can include a central command, control and communication center from which all aspects of security can be monitored and all data gathered from security sensors can be stored and analyzed. The data can be analyzed in order to anticipate possibly security breaches and automatically alert security response teams and personnel. In addition, the data can be stored in a central repository and shared with other facilities.

The system can include one or more sets of biometric and other sensors that can be used to identify individuals, vehicles and articles (luggage and packages) and monitor their flow through the facility. In addition, where the data from the biometric sensors is shared with other facilities and optionally Federal, state and local law enforcement and immigrations services, the movement of individuals, vehicles and articles can be monitored among multiple facilities. The system according to the invention can include the use of two or more biometric sensors, which serve to improve the reliability of the identification of the individual, vehicle or article. In addition, the system can detect false or copied identification articles (ID Cards, electronic pass keys and keycards, etc.) by configuring the method or system to identify that two people used the same ID card or electronic keycard in separate locations within a specified period of time where it would impossible to travel from one location to the next within that period of time, either because of the distance involved or that passage through an intermediate location would be required or because another parameter.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a flow diagram of the a method of evaluating a facility in accordance with the invention;

FIG. 2 is a diagrammatic view of a system in accordance with the invention; and

FIG. 3 is a diagrammatic view of a system in accordance with the invention.

### DETAILED DESCRIPTION OF THE PREFERRED EMBODIMENTS

The present invention is directed to a method and system for providing improved security at an existing facility or providing improved security in the design of a facility to be built. In order to facilitate a further understanding of the invention, the invention is described below as can be embodied in a method and system for improving the security at an airport. However, as a person having ordinary skill will appreciate, the present invention can be used to improve the security at the other facilities including, but not limited to, train and bus stations, harbors and shipping ports, and other facilities that serve as points of departure or arrival for travel.

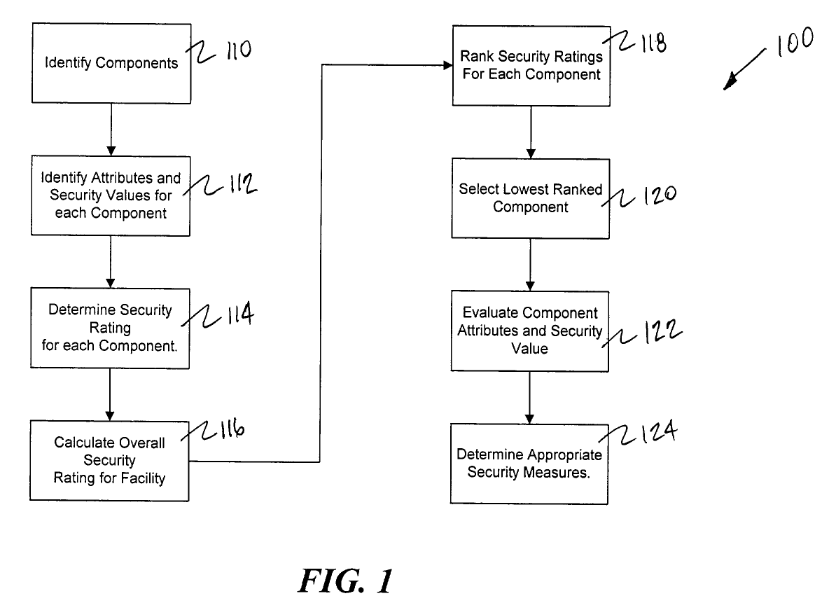

The present invention includes a method and system which can be used to evaluate an existing facility in order to determine an overall security rating for a particular facility and which can also be used identify individual or elemental weakness of the facility. The evaluation process 100, as shown in FIG. 1, includes identifying each of the component parts or elements that make up the airport facility. In our illustrative example, the components include any defined space (a terminal or gate) and access points that allow passage between any two adjacent spaces. Thus, the components include: the entrances and exits onto the airport property, the parking lots, the vehicular approaches for passenger drop-off and pickup, the passenger terminals, the airline ticket counters, the passenger security check points, the gates, the passenger ramps onto the airplanes, the runways and airfield areas, the airport perimeter and airfield boundary and the numerous access points between these areas.

Each area is assigned a unique identifier at step 110 and one or more attributes identifying characteristics of the area at step 112. Thus, the passenger terminal area can be designated as area 101 and have the following attributes: area type: defined area, number of access points: 16 (16 entrances or exits to adjacent areas), personnel access level: all passengers, visitors and employees, and level of security: 4. Each attribute can have set of predefined values associated with. For example, the area types can be:

defined area—area enclosed by walls having defined entrances and exits (e.g. passenger terminal);

undefined area—open space with undefined entrances and exits (e.g. runway and airfield);

bi-directional access point—doorway between adjacent areas which permits flow in both directions;

unidirectional access point—doorway between adjacent areas which permits flow in one direction (e.g. passenger security checkpoints);

infiltration access point—fence, wall or other physical obstacle which can be modified to provide access.

Each component is also assigned one or more security values at step 112 which reflect the level of security that is deemed appropriate or that the component requires, such as based upon an independent or user defined standard. For example, each component can be assigned an access security value which refers to the level of security at access points to enter an area or pass through an access point and monitor security value which refers to the level of security for monitoring the activities in an area or at an access point. Each level of security can be associated with a particular level of access or control. Thus, for example, level 5 can be the lowest level of security where access into and out of the area is unrestricted and security cameras are used to monitor activity in this area (such as a parking lot or parking garage); level 4 is a higher level of security where access into and out of the area is unrestricted and activity in the area is monitored by security personnel and security cameras (such as the passenger terminal); level 3 is a higher level of security where access into and out of the area is restricted to passengers and employees (of the airport and air carriers), typically after passing through a screening check point and activity in the area is monitored by security personnel and security cameras (such as a passenger gate); level 2 is the second highest level of security where access into and out of the area is restricted to airport and air carrier employees, typically through appropriate access controls, such as electronic badges or key pads, in addition level 2 areas may further restricted on an individual basis so some people will be able to access some areas whiles will not (e.g. aircraft cleaning staff would not be able to access aircraft maintenance area) and activity is the area is monitored by security cameras and security personnel and possibly a computer system that monitors and evaluates each person's presence in a particular area (such as the runways, the jet ways, the aircraft hangers and maintenance facilities, baggage screening and handling and other airport facilities); level 1 is the highest level of security where access into and out of the area is highly restricted and controlled, typically limited to those people that need to access areas determined to be likely targets or high risk areas, activity in the area is monitored by security cameras and security personnel and possibly a computer system that monitors and evaluates each person's presence in a particular area.

Other attributes can be selected in order to provide further information as to the security needs of the facility. Thus, for example, information relating to the size of the area in square feet, the height of the ceiling, amount of lighting, number of manned security on patrol can be useful in determining the requirements for a system of security cameras and other systems can also be provided.

In addition to the attributes of the component, each component can be assigned a security rating at step 114 which reflects the current level of security of a particular component. The security value can be calculated as a function of the security measures installed at the component. The security rating can be as simple as adding the number of security measures and getting a total which reflects the total number of (or levels of redundancy of) the security measures installed. Alternatively, each type of security measure can be assigned a numeric rating value which reflects the effectiveness or strength of the measure and the security rating can be the sum of all the rating values for each measure installed at a given component. The numeric ratings can be obtained from predefined ratings assigned to a given component based upon predefined company or industry standards. This rating information can be stored in a table which can be indexed and cross-referenced based upon attributes of a component or component type.

The overall security rating for the facility can be calculated at step 116 as a function of the security ratings of the individual components and can be weighted, for example as a function of the security values or the other attributes associated with the individual components. For example, the overall security rating for the facility can be sum of the security ratings for each component.

The security evaluation or audit can by conducted by one or more independent evaluators or auditors. A map or schematic of the airport facility can be used to assign identification numbers or other identifiers to the various areas, spaces and access points. This information can be input into a computer system that can be used to collect the data. The computer system can include one or more portable computers, cell phone or a personal digital assistants (PDA) or other portable device. The information can be stored in a data structure (e.g. a database, table, XML document, etc.) on each computer and downloaded to a data structure at a central repository computer for analysis and further processing. Alternatively, each computer can connected to a wired or wireless network and adapted for transferring the data to a repository computer within the computer system in real time or on a periodic basis. During the course of the evaluation or audit, the portable computer or PDA can be programmed to prompt the evaluator or auditor for information relating to the various attributes of each component (area or access point) of the facility. The program can also limit and/or check the integrity of the input of information to that which is permitted for each attribute evaluated, in order to improve the integrity of the data collected. The repository computer can further be programmed to analyze and review the data as it is received in order identify possible data errors that can be corrected while the evaluators or auditors are still on site.

After all the information is gathered and the security values for each component are determined, an overall score for the facility can be calculated at step 116. The overall score can be determined as a function of the security values, the security ratings and the attributes. In one embodiment, several ratings can be determined, a simple rating which consists of the sum of the products of the security values and the security rating for each component of the facility. A more comprehensive rating can attempt to weight the different components and the security values and ratings associated with them. In addition, the security rating could be normalized or averaged in order to compare it to other similar or dissimilar facilities.

The invention also includes evaluating the data in order to identify the weakest components and provide a report which provides a recommendation for improvements. This can be accomplished at step 118 by ranking the security components by security value, from lowest to highest, for example. Alternatively, those components which have a security value below a predetermined threshold can be identified as components in need of review and improvement. As part of a comprehensive program, a series of threshold values can be identified, whereby as components below one threshold are evaluated and improved, the entire facility can be reevaluated and components with values below a different threshold are subsequently evaluated and improved, in order to raise the minimum level of security values for any component as well as raise the overall security rating for the facility.

For each component which is selected, either because it was given one of the lowest ratings or was rated below a given threshold, the component is selected at step 120 to be evaluated for improvement at step 122. The system can identify the improvements at step 124 by providing a table which identifies types of improvements as a function of the security rating and some of the other attributes of a given component, such as the type and security rating. Thus, where a low security value is assigned to the passenger terminal, the attributes of the component can be used to lookup additional security measures to bolster security. The system would compare the attributes for the component at step 122, such as the passenger terminal to locate the same or similar attributes and then select the recommendations from the table that provide the closest match. For example, for a defined area, open to all personnel, having more than 25,000 square feet, increasing the surveillance camera coverage from 1000 square feet per camera to 250 square feet per camera or increasing security patrols from 5 to 10 persons for the same area can provide for an increase security value and improve the overall rating of the facility.

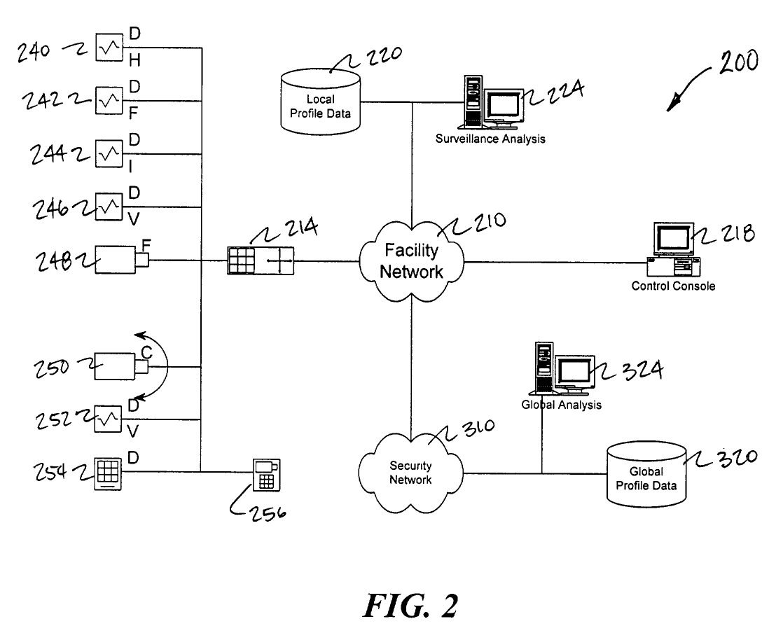

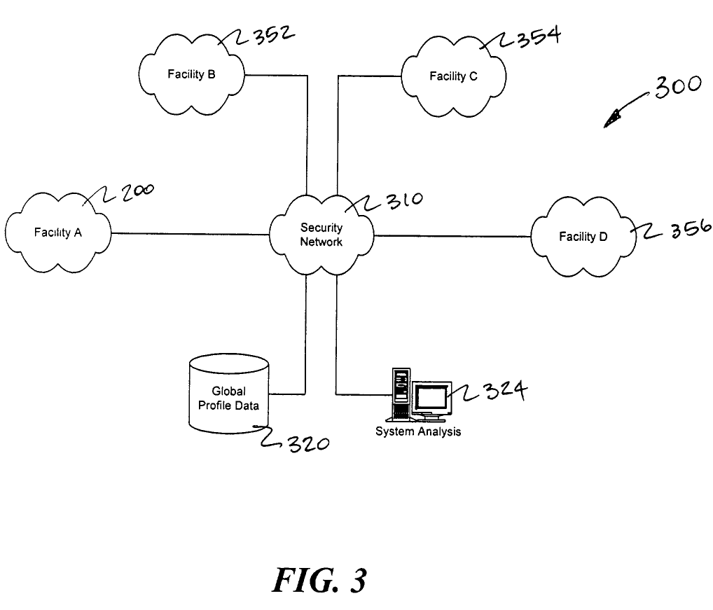

As shown in FIGS. 2 and 3, the present invention can also include a comprehensive security system 200 which includes a central command and control station 218. The security system 200 can provide for all the data gathering of information provided by various security sensors (240-256) located throughout the facility. The data from the security sensors 240-256 can be stored in a data storage device 220 in the form of a data structure, such as a database, a table, an XML based data store or plurality of flat files. For example, the data structure can be an Oracle database from Oracle Corporation, Redwood Shores, Calif. The security system 200 can also provide for redundancy and backup (not shown), in the event that the central station 218 is compromised in any manner. Where the facility has multiple terminals, several command control stations 218, each capable of functioning independently of the other, but having complete access and control over the entire facility can be used to provide the desired level of redundancy. In addition, an off site location can also be connect to the facility, in order to provide remote access and control as well as provide for redundant archival storage of the data collected.

The backbone of the system can be security management system 200, such as a system based upon the C-Cure Security Management System available from Sensormatic Electronics Corp., Boca Raton, Fla. The security management system can be used to restrict access to the airport facility by area, day and time as well as to automatically lock and unlock access doors or other control points at specified times.

All airport facility personnel can be required to wear photo identification badges which can be adapted to be read by electronic or magnet readers 254 to control and monitor access throughout the facility. The photo badges be can produced by a system based upon the Photo ID Badging system available from ADT Security Services, Boca Raton, Fla. The Photo ID Badging system can be adapted to gather personnel identification data that is utilized by the system to verify the person's identity as they are granted access throughout the facility. This data can include hand, fingerprint, voice, facial recognition, retinal, iris and other personnel identification data. The system can also monitor the access of person throughout the facility to detect events that might warrant further investigation. For example, where a person's badge entering a first location and then entering a second location within a short period of time when the distance between the locations is large enough to suggest that a badge has been copied or that an intermediate access point did not record the person passing through. In addition, the system may record that a person accessed a particular location on a particular day when they were not scheduled to work that day, would trigger an event that might warrant further investigation.

The facility can be provided with a plurality of biometric and other sensors throughout the facility in order to record information or attribute data about people and objects entering the facility. These can include hand 240 and fingerprint 242 identification scanners, such as HandKey available from Recognition Systems, Inc. of Campbell, Calif.; facial recognition scanning systems 248 such as FaceIt available from Visionics Corp. of Jersey City, N.J.; Iris and retinal scanning systems 244; and voice identification systems 246. These systems can be used to collect identifying data about individuals that can be used in subsequent passage through a security checkpoints to verify a persons identity because the stored information (the previously recorded information or attribute data) can be compared to information (attribute data) collected at the checkpoint. This verification can be used in combination with identification cards to verify the identity of a person or an object. The identification cards can be government issued ID cards or facility issued ID cards as described below. The biometric information collected can be processed by processing equipment 214 which converts the sensor signals to biometric attribute data that can be routed through the facility network 210 to data storage devices 220. Once the biometric information or attribute data is stored at the facility in the local profile data storage 220, the information can be recalled at any checkpoint in the system 200 using the facility network 210 which can include wired and wireless stations.

The facility can include monitoring biometric sensors 250 which allow scanning of, for example, faces in a crowd and a system 224 can be provided which can compare the scanned faces with facial image data stored in the local profile database in order to identify people who present potential security risks, using facial recognition such as Face ID from ImageWare Systems, Inc. of San Diego, Calif. Similarly, objects, such as luggage and vehicular traffic can be monitored in order to identify luggage or vehicles that present potent security risks, using object and vehicular identification systems, such as Vehicle ID from ImageWare Systems, Inc. of San Diego, Calif. and transponder based systems (FastLane used by the Commonwealth of Massachusetts and EZPass used by the State of New York) from Mark IV Industries, Amherst, N.Y. This information can be distributed to a centralized global profile data store 320 which can collect and redistribute data among more than one facility. The data can be stored in data structure, such as a database, a table, an XML data structure or a series of files that enable the information to be searched as well as distributed to other facilities. The global profile data base 320 can be supplemented with data collected by Federal, state and local law enforcement and related agencies in order to further facilitate security. For example, where biometric data from non-resident aliens traveling as visitors within the country is collected at immigration and passport checkpoints, the system can be used to alert authorities of the travel of these individuals. In addition, where the visa of an individual has expired, for example, the system can alert the appropriate authorities and allow them to take appropriate action. The information can also be used to reduce the ability of people to use false identification at these and other locations where the person's biometric data can be used to verify their identity.

The facility can also include sensor systems for monitoring or tracking luggage (and parcels or other objects carried by passengers). At check-in, each piece of luggage can be provided with a tag, such as a luggage tag that can be detected by sensors throughout the facility. These sensors can include electromagnetic sensors and optical sensors that actively or passively detect the presence of the tag in a specific location.

The personnel identification data, along with similar passenger identification data can be stored in the central command and control center of the airport facility 218. In addition, all the identification data can be transmitted to the central repository 320 where the data is accessible by other airport facilities as well as Federal, state and local law enforcement agencies.

In one embodiment, the system includes a personal identification screening station where personal identification and attribute data and information from each person can be obtained. The station can include a booth or enclosure having one or more security sensors including, but not limited to a fingerprint scanner for capturing fingerprint data, a camera for capturing facial images and data for facial recognition processing, an audio transducer for capturing a person's speech data for use in speech recognition profiling and a retinal scanner for capturing retinal data for use in retinal scanning identification. Preferably, this station can gather all this information in a relatively short period of time and possibly, some of the information simultaneously. The data can be stored in the central command and control station 218 or at another secure location within the airport facility, such as a data analysis system 224 of the facility. Alternatively, the information can be stored remotely from the airport facility, such as a single or multi-facility data storage device 320.

The security system can also include access control devices that control the access of facility personnel and other authorized contractors and visitors throughout the facility. Access can be controlled by one or more means of access control, including electronic, proximity, magnetic or other card readers, alpha-numeric keypad key code access controllers, fingerprint identification systems, voice identification systems, facial recognition identification systems and retinal identification systems 252. Preferably, each access point includes more than one type of access control system, such as a proximity card reader in combination with an alpha-numeric key code access system 254 or an alpha-numeric key code access system in combination with a biometric scanner 256, such as facial, retinal or iris scanning system. The security measures at each access point can be selected to reflect the appropriate level of security for that access point.

The security management system can, for example, at the control console 218 or the surveillance analysis system 224, track the movements of all personnel and objects throughout the facility as well as produce time and attendance reports for all personnel. The system can further be adapted to detect intrusions where, for example an access card is cloned or copied, the system could identify that an access card used at one location, could not possibly be used in another location within a give time period based upon the distance between them, for example or because access to the second location requires accessing at least one other location, for which the system has no record.

The security management system can also monitor and record the events on a security camera system such as a closed circuit television (CCTV) surveillance camera system which allows for tracking of individuals throughout the facility. The security camera system can be based upon the DeltaDome, Speed Dome, American Dynamics Tracker Dome camera systems available from Sensormatic Electronics Corp., Boca Raton, Fla. All the video information can be controlled to allow processing, including simultaneous display and recording using a system based upon the American Dynamics matrix system and Robot multiplexers available from Sensormatic Electronics Corp., Boca Raton, Fla. The video can be recorded 24 hours a day on a system using American Dynamics time lapse video recorders or Intellex digital recorders available from Sensormatic Electronics Corp., Boca Raton, Fla.

The appropriate cameras of the security camera system can be programmed to turn toward and focus on a particular location upon the triggering of an event. Thus, for example, the cameras adjacent a particular access point can turn toward and record the access and egress whenever passage is attempted. In addition, panic or emergency alarm switches or buttons can be provided at locations that would provide security personnel to trigger an event that would draw the attention of adjacent surveillance cameras as well as other actions including dispatching additional security or other personnel to the location. All aspects of the event and the system response to the event can be recorded and archived, including time and date stamps to provide supervisory review and evaluation and also preserve the admissibility as evidence in court.

The system can also include vehicle gate controllers to secure vehicular entrances and exits. The vehicle controllers can include micro box gate controllers and XL hydraulic operators available from Sensormatic Electronics Corp., Boca Raton, Fla. The gate controllers can be accessed through the same access systems described above, including proximity access card and other identification means through a guardstation console, such as the C-Cure guardstation console available from Sensormatic Electronics Corp., Boca Raton, Fla. The gates can determine whether to open for a vehicle or only a few feet for a pedestrian. The gates can also detect vehicle loitering, vehicle back out, vehicle loop failure, tailgating, gate forced open, gate open too long, gate not closed, unsafe entry, early departure, wrong direction, pedestrian entry, power failure, maintenance due counters and several tampers.

The security system can further include a passenger identification system which can either be implemented at the entrance to the airport terminal or at airline passenger check-in counters where passengers check their luggage and receive tickets, boarding passes and/or seat assignments. At either of those locations, a passenger identification system can compare the passenger's documentary identification (passport, driver's license or other ID) with the person's identification based upon personal information and attribute data in the system. Thus, where each passport holder or driver's license holder has been previously subject to a personal identification screening as outlined above, the person's fingerprint, voice profile, facial information or retinal scan can be compared with the corresponding attribute data stored in the system to verify the person's identification.

The system can further include additional passenger identification systems at each security check point and/or at each gate. This can enable the system to verify that the person who checked in at the airline check-in counter actually boarded the correct airplane. The system can further log the number of parcels or bags a person is traveling with, the number of check pieces and the number of carrying-on pieces. This information can be used to verify that each checked item and each carry on item can be associated with a person that boards the plane at the gate. In addition, the information about an individual's travel can also be logged and forwarded to the central repository for future use.

The facility can also be equipped with various intrusion detection sensors and devices in areas that are normally closed to the flow of people and vehicles. These areas can include storage facilities and other areas that can be closed to the public and employees during certain periods. The intrusion detection sensors and devices can include CCTV, ultrasonic, passive and active infrared, audio, floor based weight/pressure, optical (including laser based sensing devices), moisture and other types of detection devices which can be used to alert the presence of people in an area.

In one embodiment, each employee, passenger at check-in and each object can be provided with GPS sensor tag that reports the location of the sensor tag to the security management system 200 via a wireless network (such as an RF, BlueTooth or infrared communication medium). The departing passengers can use the GPS sensor tags throughout the facility and surrender them at the gate upon boarding the airplane or arriving passengers can be provided GPS sensor tags upon deplaning and surrender the GPS sensor tags upon retrieving their checked luggage and leaving the airport. Similarly, a GPS sensor tag can be attached to each piece of carry-on luggage to track its movements within the facility.

The facility can further be outfitted with blast mitigation products in order to reduce injury caused by an explosion. The glass windows of the airport facility can be protected using a film based glass protection systems such as GlassLock available from ADT Security Services, Boca Raton, Fla. Alternatively or in addition, protective drapery systems can be used to mitigate injury caused by flying debris, such as SafetyDrape available from ADT Security Services, Boca Raton, Fla.

FIG. 3 shows a system in accordance to the invention wherein the multiple facilities 200, 352, 354, and 356 are interconnected by a security network 310 which can include both wired and wireless connections. The attribute data, including biometric and other data can be forwarded to the global profile data store 320 which allows for distribution to many facilities. This system can also allow for detection of false or duplicate identification by having each facility report the detection of each individual to the global profile data store 320 where a system 324 can analyze the information to identify the travel of predetermined persons, such as those with expired visas or travel papers. Similarly, where the system detects that the same person is identified as passing through two distant locations at essentially the same time or within an unreasonably small amount of time, it can presumed that one is using a false identification. Additional analysis of this information can be conducted to determine suspect travel patterns and anticipate suspect activity. Preferably, this is conducted by a government or independent agency which can protect the privacy of the people who's information is stored in the system.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A method of evaluating a facility comprising:
identifying components of said facility, said components optionally including associated security measures;
evaluating each component to determine an appropriate security level for that component; and
rating each component as a function of the security measures associated with said component.

2. The method according to claim 1 further comprising:
determining a security rating for each component as a function of the security measures associated with said component.

3. The method according to claim 2 further comprising:
ranking the components as a function of said security rating.

4. The method according to claim 2 further comprising:
determining a security rating for each component as a function of the security rating for said component and an evaluation value determined as a function of the evaluation of said component to determine an appropriate security level for that component.

5. The method according to claim 4 further comprising:
ranking the components as a function of said security rating.

6. The method according to claim 2 further comprising:
determining a security rating for each component as a function of the product of the security rating for said component and an evaluation value determined as a function of the evaluation of said component to determine an appropriate security level for that component.

7. The method according to claim 6 further comprising:
ranking the components as a function of said security rating.

8. The method according to claim 2 further comprising:
determining a security rating for the facility as a function of the security rating for at least one of the components of the facility.

9. The method according to claim 2 further comprising:
determining a security rating for the facility as a function of the security rating for at least one component of the facility and an evaluation value determined as a function of the evaluation of said at least one component to determine an appropriate security level for said at least one component.

10. The method according to claim 9 comprising determining the security rating for the facility as a function of the security rating and the evaluation value determine for at least two components of the facility.

11. The method according to claim 10 comprising determining the security rating for the facility as a function of the sums of the products of the security rating and the evaluation value determine for said at least two components of the facility.

12. The method according to claim 2 further comprising:
ranking the components as a function of said security rating.

13. The method according to claim 1 further comprising:
determining a security rating for each component as a function of the security measures associated with said component and an evaluation value determined as a function of the evaluation of each component to determine an appropriate security level for that component.

14. The method according to claim 13 further comprising:
ranking the components as a function of said security rating.

15. A system for evaluating a facility comprising:
a computer processor and associated memory and data input devices,
a data structure adapted for storing information relating to at least one component of said facility, said at least one component optionally including associated security measures and said data structure being adapted to store information relating to said associated security measures.

16. The system of claim 15 wherein said data structure is adapted to store information relating to an appropriate security level for said at least one component.

17. The system of claim 15 wherein said data structure is adapted to store information relating to a security rating for said at least one component.

18. The system of claim 17 wherein said security rating is determined as a function of the security measures associated with said at least one component.

19. The system of claim 15 further comprising a data communications link for transmitting information stored in said data structure to a central repository.

20. The system of claim 15 wherein said data structure is a database.

21. The system of claim 15 wherein said data structure is an XML document.

22. The system of claim 15 further comprising:
a subsystem for comparing information relating to said at least one component of said facility to a set of predefined information relating to possible components of a facility and modifying said information relating to said at least one component.

23. The system of claim 22 wherein said set of predefined information includes predefined security ratings for possible components of a facility and said subsystem modifies a security rating in said information relating to said at least one component as a function of said information relating to said at least one component and said predefined information.

24. The system of claim 15 wherein said data structure includes information relating to a plurality of components of said facility, said system further comprising:
a subsystem adapted for determining a security rating for each component as a function of the security measures associated with said component.

25. The system of claim 24 further including a subsystem adapted for ranking the components as a function of said security rating.

26. The system of claim 24 further comprising:
a subsystem adapted for determining a security rating for each component as a function of the security rating for said component and an evaluation value determined as a function of the evaluation of said component to determine an appropriate security level for that component.

27. The system of claim 26 further comprising:
a subsystem adapted for ranking the components as a function of said security rating.

28. The system of claim 24 further comprising:
a subsystem adapted for determining a security rating for each component as a function of the product of the security rating for said component and an evaluation value determined as a function of the evaluation of said component to determine an appropriate security level for that component.

29. The system of claim 28 further comprising:
a subsystem adapted for ranking the components as a function of said security rating.

30. The system of claim 24 further comprising:
a subsystem adapted for determining a security rating for the facility as a function of the security rating for at least one of the components of the facility.

31. The system of claim 24 further comprising:
a subsystem adapted for determining a security rating for the facility as a function of the security rating for at least one component of the facility and an evaluation value determined as a function of the evaluation of said at least one component to determine an appropriate security level for said at least one component.

32. The system of claim 31 comprising a subsystem adapted for determining the security rating for the facility as a function of the security rating and the evaluation value determine for at least two components of the facility.

33. The system of claim 32 comprising a subsystem adapted for determining the security rating for the facility as a function of the sums of the products of the security rating and the evaluation value determine for said at least two components of the facility.

34. The system of claim 24 further comprising:
a subsystem adapted for ranking the components as a function of said security rating.

35. The system of claim 15 wherein said data structure includes information relating to a plurality of components of said facility, said system further comprising:
a subsystem adapted for determining a security rating for each component as a function of the security measures associated with said component and an evaluation value determined as a function of the evaluation of each component to determine an appropriate security level for that component.

36. The system of claim 35 further comprising:
a subsystem adapted for ranking the components as a function of said security rating.

37. A security system for a facility comprising:
a plurality of computer systems interconnected by a communication network for transmitting and receiving data over said network,
a data storage device operatively connected with a first computer system for storing security information, said security information including stored attribute data representative of at least one attribute of a person or an object,
a plurality of sensing devices operatively connected to said network for transmitting and receiving data over said network, said sensing devices being adapted to detect at least one attribute of a person or an object and being adapted for generating sensed attribute data representative of said at least one attribute; and
means for comparing said sensed attribute data with said stored attribute data.

38. An inter-facility security system comprising:
a plurality of facilities, each facility including at least one computer system connected to a common communication network for transmitting and receiving data over said communication network;
a central data storage system operatively connected to said communication network for storing security information, said security information including stored attribute data representative of at least one attribute of a person or an object,
at least one of said plurality of facilities including at least on sensing device operatively connected said at least one computer system of said facility for transmitting and receiving data to and from said at least one computer system, said at least one sensing device being adapted to detect at least one attribute of a person or an object and being adapted for generating sensed attribute data representative of said at least one attribute; and
means for comparing said sensed attribute data with said stored attribute data.
